(19) United States
(12) Patent Application Publication
(10) Pub. No.: US 2003/0164654 A1
(43) Pub. Date: Sep. 4, 2003

(54) Axially segmented permanent magnet synchronous machine with integrated magnetic bearings and active stator control of the axial degree-of-freedom

(76) Inventors: Edgar S. Thaxton, Bradford, RI (US); Carl J. Jensen, Waterford, CT (US)

Correspondence Address: BAKER & BOTTS, 30 ROCKEFELLER PLAZA, NEW YORK, NY, 10112

(21) Appl. No.: 10/082,976

(22) Filed: Feb. 25, 2002

(51) Int. Cl. H02K 7/09

(52) U.S. Cl. 310/90.5

(57) ABSTRACT

In the embodiments described in the specification, a permanent magnet synchronous machine has axially spaced stator and rotor segments and windings in the stator segments are supplied with AC signals to produce motor torque, integrated magnetic bearings and active control of the rotor position in six-degrees of freedom. The rotor segments may be axially offset inwardly or outwardly with respect to the rotor segments.

### BACKGROUND OF THE INVENTION

This invention relates to permanent magnet machines with integrated magnetic bearings having active stator control.

In conventional axially segmented permanent magnet synchronous machines with integrated magnetic bearings, five-degrees of freedom stabilization and control is obtained with a limited passive reluctance centering force naturally occurring in the axial, or sixth-degree of freedom. Thus, the limitation of a five-degrees of freedom axially segmented permanent magnet synchronous machine with integrated magnetic bearings is that it can only be utilized for applications in which the axial forces developed by the machine system and its attached loads are not severe. Additionally, a five-degrees of freedom axially segmented permanent magnet synchronous machine with integrated magnetic bearings has no inherent capability of canceling axial vibration or noise because it cannot inject forces in the axial degrees of freedom.

The patents to Trumper U.S. Pat. No. 5,196,745 and Hazelton et al. U.S. Pat. No. 6,208,045 disclose linear motors or actuators having magnetic suspension of a linearly moving component using coil arrays and magnets with six-degrees of freedom.

The Putnam et al. U.S. Pat. No. 5,126,641 discloses a bi-directional variable reluctance linear actuator for active attenuation of vibration and noise and control of a rotating shaft in up to six-degrees of freedom.

The Osama et al. U.S. Pat. No. 6,166,469 describes an active axial force control arrangement for a multi-segment machine having axially offset rotor segments to eliminate the need for axial bearings.

U.S. Pat. No. 6,218,751 to Bohlin discloses a magnetic bearing assembly with off center magnets for biasing axial force components.

The Takahashi et al. U.S. Pat. No. 6,111,333 describes a rotating machine having magnetic bearings with an active vibration control arrangement.

### SUMMARY OF THE INVENTION

Accordingly, it is an object of the present invention to provide an axially segmented permanent magnet synchronous machine which overcomes disadvantages of the prior art.

Another object of the invention is to provide an axially segmented permanent magnet synchronous machine having integrated magnetic bearings and having active control of the axial degree of freedom.

These and other objects of the invention are attained by providing an axially segmented permanent magnet synchronous machine with integrated magnetic bearings in which axial stabilization is produced by reaction forces resulting from axial displacement of the rotor which generates signals fed to respective stator windings to enable the air gap magnetic fields to be maintained at constant intensity during axial rotor displacement.

By generating signals resulting from axial displacement and supplying them to stator windings to maintain the air gap magnetic fields at constant intensity, it is possible to provide axial anti-vibration noise control and maintain smooth operation of the machine throughout a broad range of operating conditions.

In a particular embodiment, both the rotor and the stator are axially segmented and the axial restoring force produced by stator segments in response to detection of small axial displacement of the rotor with respect to a corresponding stator segment is generated by current supplied to the stator windings in such a way as to maintain the air gap magnetic fields at constant intensity during actual displacement. Preferably, the segments of the rotor and stator are axially offset from each other and the signals applied to the stator windings bias the rotor segments toward a centralized location.

### BRIEF DESCRIPTION OF THE DRAWINGS

Further objects and advantages of the invention will be apparent from a reading of the following description in conjunction with the accompanying drawings in which:

FIG. 1 is a schematic cross-sectional view illustrating a representative embodiment of a permanent magnet synchronous machine with integrated magnetic bearings providing active stator control in six-degrees of freedom in accordance with the invention;

FIG. 2 is a fragmentary view illustrating the forces occurring between a stator segment and a rotor segment which is axially offset from the stator segment;

FIG. 3 is a schematic cross-sectional view similar to FIG. 1 illustrating the axially force produced in response to axial displacement of the rotor with respect to the stator;

FIG. 4 is a schematic cross-sectional view illustrating an embodiment in which rotor segments are offset inwardly with respect to adjacent stator segments;

FIG. 5 is a schematic cross-sectional view illustrating an embodiment of the invention in which rotor segments are offset outwardly with respect to adjacent stator segments;

FIGS. 6A and 6B are schematic cross-sectional views illustrating the axial forces produced on a rotor having inwardly offset segments with respect to the adjacent stator segments when the rotor is displaced in opposite axial directions, respectively;

FIGS. 7A and 7B are schematic cross-sectional views illustrating the axial forces produced on a rotor having outwardly offset segments with respect to the adjacent stator segments when the rotor is displaced in opposite axial directions, respectively;

FIG. 8 is a schematic cross-sectional view illustrating another embodiment of the invention utilizing a segmented stator and a non-segmented rotor; and

FIGS. 9A and 9B illustrate the forces applied to the rotor of FIG. 8 when it is displaced in opposite axial directions, respectively.

### DESCRIPTION OF PREFERRED EMBODIMENTS

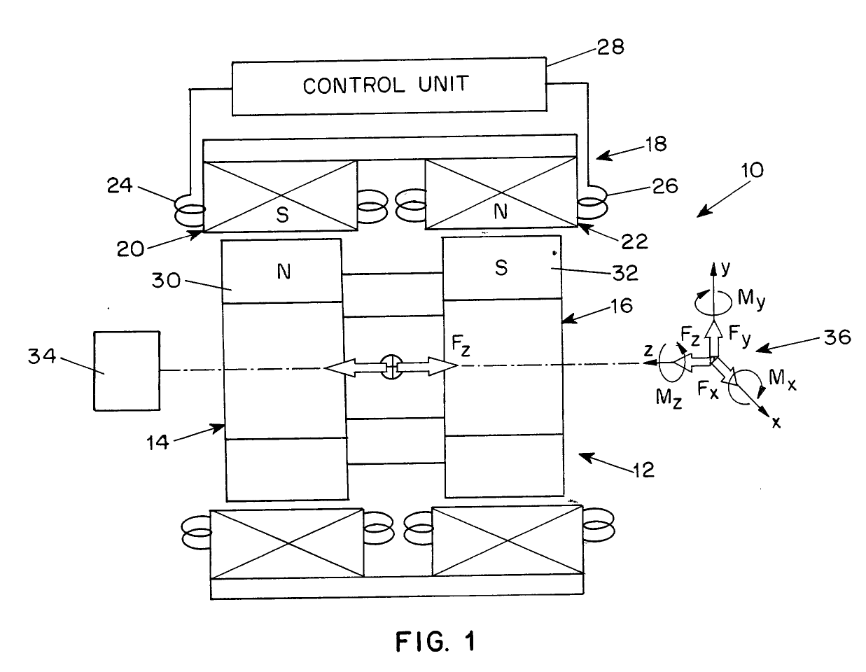

In the typical embodiment of the invention illustrated in FIG. 1, a permanent magnet machine 10 has a rotor 12 containing two axially spaced segments 14 and 16 surrounded by a stator 18 having two axially spaced segments 20 and 22 surrounding the rotor segments 14 and 16, respectively. The stator segments 20 and 22 are provided with windings 24 and 26, respectively, which receive signals from a control unit 28 to generate magnetic fields that interact with permanent magnets 30 and 32, respectively in the rotor. The control unit 28 can detect changes in the axial location of the rotor 16 from changes in the emf induced in the windings 24 and 26 by the rotor magnets 30 and 32.

The magnetic fields produced by the windings 26 and 28 by AC signals supplied from the control unit 28 are controlled not only to cause rotation of the rotor 12 in the usual manner but also to produce instantaneous forces attracting or opposing the permanent magnets 38 and 32 in such a way as to produce an integrated magnetic bearing supporting the rotor 12 centrally within the opening in the stator 18 and also maintaining the rotor position centrally in the axially direction within the stator, i.e., in six-degrees of freedom.

The rotor 12 may be coupled to another component 34 which may, for example, be a load if the machine is operating as a motor or a drive source if the machine is acting as a generator.

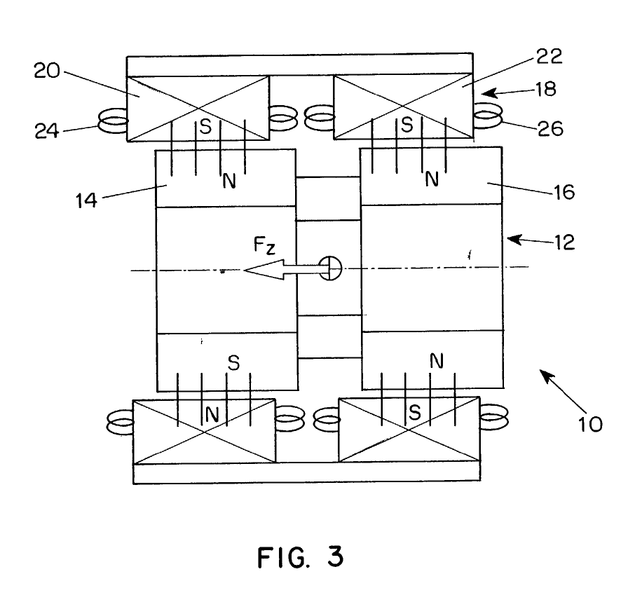

As shown in the diagram 36 of FIG. 1, the motor action represented by the symbol M_{z} induces rotation of the rotor 12 around the axial axis labeled z and the integrated magnetic bearing action of the stator coils maintains the rotor oriented properly with respect to the stator in two orthogonal axes x and y, which are also orthogonal to the axis z, by applying forces designated Fₓ, and F_{y}. In addition, in order to maintain the rotor centrally positioned within the stator, the signals supplied to the windings 24 and 26 include components which generate a force F_{z} in response to detected axial displacement of the rotor 12 away from the central position of the rotor within the stator as shown in FIG. 3.

Thus, the term “active stator control” means that the stator windings of some or of all of the stator segments in the machine control the production of the axial stabilization and control force F_{z} utilizing the existing stator windings 24 and 26 to create a controllable magnetic attractive shear force in the axial degrees of freedom of the segmented permanent magnet synchronous machine with integrated magnetic bearings when the rotor segments undergo small displacements relative to the stator segments or when the system is initialized with a pre-existing angle of displacement. The active stator control methods are summarized as follows:

a) with individual participating rotor/stator segments, the amplitude of the AC signal applied to the stator segment windings 24 and 26 is enhanced to obtain a variable and controllable axial restoring force F_{z} when the rotor segments 12 and 14 experience small axial displacements relative to their stator segments 20 and 22; or

b) with multiple participating rotor and stator segments, the amplitudes of the AC signals applied to the stator segment in offset or biased rotor/stator paired segments is varied to provide competing preferential axial positioning forces to produce an enhanced controllable axial system force without the system having to experience an initial axial displacement.

It will be understood that rotor 12 and the stator 18 may have any number of axially spaced segments and that some of the segments may have different axial or radial dimensions or power levels than other segments and that fewer than all of the segments may provide torque action or magnetic bearing action or axial positioning action.

Both of these active axial control methods are variations of the same concept; i.e., amplification and/or variation of the AC current signals supplied to a stator segment to convert a would-be passive reluctance centering force into a controlled active axial force in an axially segmented permanent magnet synchronous machine with integrated magnetic bearings. Operationally, the main difference between the two methods is that the first method cannot preemptively inject axial forces while the second method can inject them for the purpose of noise cancellation. This method provides true six-degrees of freedom stabilization and control to axially segmented machine systems.

The embodiments of this invention enhance and control and hence make active the natural passive magnetic attractive axial shear force between the rotor and stator of the participating axial machine/integrated magnetic bearings segments by manipulating the AC current signals fed to their respective stator windings. Thus, the magnetic fields in the air gap of the machine and/or integrated magnetic bearings can be maintained at constant intensity as axial displacement occurs (passive case) or they can be intensified and controlled as desired. Injecting currents into the windings in the stator segments for the purpose of creating axial force on the rotor shaft can also be used for the purpose of creating axial anti-vibration forces that can help maintain smooth and quiet operation of the axial machine system in a broad range of operating conditions and for attenuating flexural shaft modes by supplying counteracting forces to the shaft.

Under axial displacement of the rotor relative to the stator in conventional motor/generator systems the integrated magnetic bearing function tends to weaken and lose effectiveness as the reluctance of the system increases and the inductance decreases. To make up for this difference in system performance, and more importantly, to maintain the axial machine system in optimum operating condition, the working magnetic fields have to be enhanced. The forces produced in a machine system and, more specifically, in the air gap between flux carrying components of the stator and the rotor, is strictly a square function of the air gap magnetic field. The derivation of the controllable axial force equation for a rotating electrical machine is straightforward and as follows:

The well known relationship between magnetic flux density, B, and magnetic field intensity, H, is:

B=μ₀H (1)

where μ=Permeability of free space (4π×10⁻⁷ H/m).

The magnetic field intensity, H, is application-specific and for this electric machine application, the working magnetic flux must make two passes through the air gap and the air gap path length dominates the magnetic circuit. The magnetic field intensity becomes:

$$H = \frac{amp \cdot turns}{pathlength} = \frac{NI}{2 g} , \qquad ( 2 )$$

where:

N=number of turns of current carrying conductor;

I=current (Amps); and

g=air gap radial length (m).

The magneto-motive force, mmf, or more simply, F, is defined as:

mmf=F=NI. (3)

The relationship between magnetic flux density, B, and magnetomotive force, F, can now be established as

$$B = \frac{{μ}_{0} NI}{2 g} = \frac{{μ}_{0}}{2 g} F . \qquad ( 4 )$$

The magnetic stored energy Wₘ of a typical electric machine is a function of the machine's rotating magnetic fields (stator and rotor) and the reluctance or the inductance of the air gap path through which the working magnetic fields pass. From this, the air gap magnetic energy equation of the rotating stator and rotor magnetic fields can be represented as follows:

Wₘ=(volume·of·airgap)(energy·density·of·airgap)=V_{airgap}●wₘ, (5)

and the volume of the air gap can be defined as:

V_{airgap}=πDgl, (6)

where:

D=average diameter of air gap (m); and

I=axial length of machine (m).

Based on the inductive energy associated with the rotating stator and rotor magnetic fields and the self-and mutual-flux paths typically associated with an electric machine, the magnetic energy of the air gap region is found to be:

$${W}_{fld} = \frac{1}{2} {L}_{ss} {i}_{s}^{2} + \frac{1}{2} {L}_{rr} {i}_{r}^{2} + {L}_{sr} {i}_{s} {i}_{r} cos δ , \qquad ( 7 )$$

where:

Lₛₛ=Self Inductance for stator (henries);

Lᵣᵣ=Self Inductance for rotor (henries);

Lₛᵣ=Mutual Inductance between stator and rotor (henries); and

δ=space-phase angle between magnetic axis of the stator and rotor (Torque Angle, radians).

From equation 7, the definition of inductance, and magneto-motive force, the magnetic energy density for this machine application, utilizing the nomenclature defined above, becomes:

$${w}_{m} = \frac{{μ}_{0}}{4 {g}^{2}} ( {F}_{s}^{2} + {F}_{r}^{2} + 2 {F}_{s} {F}_{r} cos δ ) , \qquad ( 8 )$$

where:

Fₛ=Nₛ,Iₛ, Peak value of the stator mmf (magnetomotive force) wave (amp-turns); and

Fᵣ=NᵣIᵣ, Peak value of the rotor mmf (magnetomotive force) wave (amp-turns).

Note that for a permanent magnet rotor, the Nᵣ,Iᵣ, and thus the Fᵣ, is a fixed and constant value depending only on the strength and size of the magnets used and the geometry and relative permeability of the surrounding rotor ferromagnetic material. Therefore, the stored magnetic energy of the machine, as a function of the air gap geometry, the current in the N-turn stator windings, and the angle between the rotating stator and rotor magnetic fields is expressed by the relatively simple equation:

$${W}_{m} = \frac{π {μ}_{0} Dl}{4 g} ( {F}_{s}^{2} + {F}_{r}^{2} + 2 {F}_{s} {F}_{r} cos δ ) . \qquad ( 9 )$$

To include the effects of an axially displaceable rotor, the air gap volume equation must be modified to show the effects of an axial displacement of the rotor within the stator as follows:

$${V}_{airgap} = π Dgl ( 1 - \frac{x}{l} ) , \qquad ( 10 )$$

where x is the axial displacement of the rotor. Upon reinsertion of the modified air gap volume equation, the air gap magnetic energy equation becomes:

$${W}_{m} = \frac{π {μ}_{0} Dl}{4 g} ( 1 - \frac{x}{l} ) ( {F}_{s}^{2} + {F}_{r}^{2} + 2 {F}_{s} {F}_{r} cos δ ) . \qquad ( 11 )$$

Conservation of energy principles dictate that a force Fx will be developed if there is a change in stored energy in the system upon a position displacement x in a conservative field:

$${F}_{x} = \frac{\partial {W}_{m}}{\partial x} . \qquad ( 12 )$$

Therefore, taking the partial derivative of the air gap magnetic energy with respect to the axial displacement yields:

$${F}_{circ} = \frac{π {μ}_{0} D}{4 g} ( {F}_{s}^{2} + {F}_{r}^{2} + 2 {F}_{s} {F}_{r} cos δ ) . \qquad ( 13 )$$

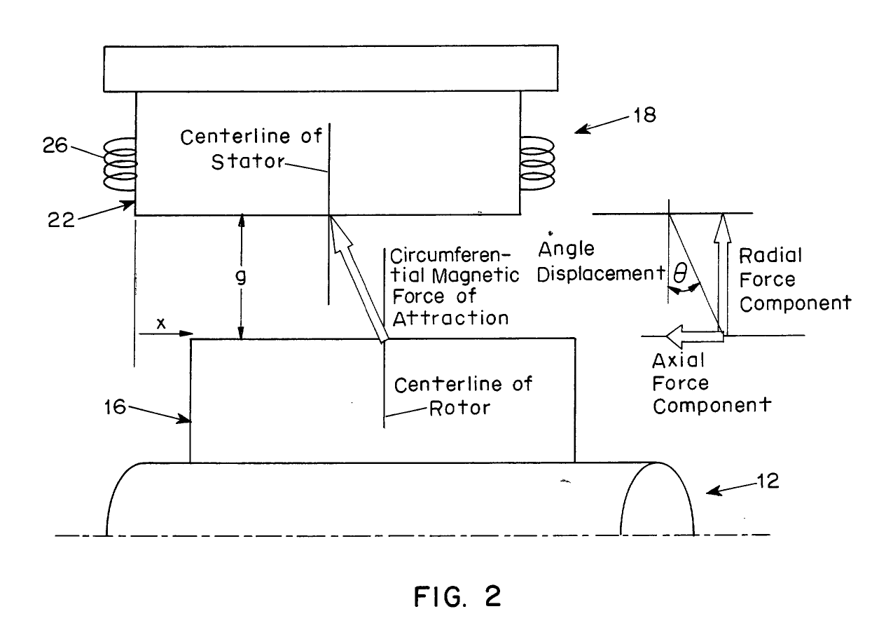

Equation 13 provides a good approximation of the total circumferential force of attraction between the two magnetic flux-carrying bodies and is valid for small axial displacements where flux “crowding” and thus saturation is minimized. Equation 13 shows that the total circumferential magnetic force of attraction between the rotor and the stator, for small axial displacements that do not bring on saturation, is independent of axial position and remains relatively constant under such displacements. However, as shown in FIG. 2, upon small axial displacement, the originally radial-only circumferential force becomes vectored into radial and axial circumferential forces of attraction between the rotor 12 and the stator 18. Thus, the axial shear force component of attraction between the rotor and stator, under small axial displacement, is not constant and is directly proportional to the magnitude of an axial displacement x by the sine of the angle of displacement.

As shown in FIG. 2, θ is the angle of displacement from the vertically centered position between the rotor and the stator where:

$$θ = {tan}^{- 1} ( \frac{displacement}{gap} ) = {tan}^{- 1} ( \frac{x}{g} ) , \qquad ( 14 )$$

and sinθ gives the axial component of the composite magnetic force vector as the rotor is displaced relative to the stator. Finally, the complete equation describing the controllable axial displacement force for each participating axial rotor/stator segment is stated as follows:

$${F}_{axial} = {F}_{circ} sin θ = \frac{π {μ}_{0} D}{4 g} ( {F}_{s}^{2} + {F}_{r}^{2} + 2 {F}_{s} {F}_{r} cos δ ) sin θ . \qquad ( 15 )$$

Thus, the total magnetic force of attraction between rotor and stator, for small axial displacements, is independent of rotor axial position; however, the axial shear force between rotor and stator is not constant but is directly proportional to the axial displacement of the rotor relative to the stator. Note that the total magnetic force of attraction, and the corresponding vectored utilization of the axial component, is a maximum for small values of torque angle, δ and a minimum for large δ. Hence, unlike the machine's torque equation, where torque is a function of the sine of δ and is therefore a maximum for large values of torque angle δ, the developed axial force, and the injection of current to increase this effect, will be more effective at smaller space-phase angles between the rotor and stator magnetic fields.

As shown by the nonlinear nature of Equation 15, a slight increase in stator winding current levels will bring a significantly stronger (by a modified square relationship) increase in the axial shear force. This increases the air gap flux levels as axial displacement between the rotor and stator takes place, thereby strengthening the flux paths for the traditional motor/generator machine work, the work of the integrated magnetic bearings, and the attractive shear force work to counter the force causing the axial displacement.

The injection or enhancement of current signals applied to the stator windings 24 and 26 for the purpose of creating axial forces on a displaced rotor is possible up to the saturation level of the ferromagnetic magnetic flux in the material through which the flux passes. For this reason, where it is known that substantial axial forces must be generated with the active stator control feature of the axially segmented machine, substantial magnetic flux saturation “headroom” may be built into the design so that operation in the saturation region may be avoided.

FIG. 3 illustrates the case in which an axial force F_{z} is produced by AC current amplification with a zero initial angle of displacement and, upon axial displacement, a strengthening of existing AC current signals occurs within each or some of the symmetrically aligned (zero initial angle of displacement) magnetically isolated rotor/stator segments. This works within each machine segment to strengthen the magnetic coupling between the rotor and stator when the coupling would otherwise be diminished because of the decreasing effectiveness of the radial component of the air gap magnetic field as axial displacement occurs. With a symmetrically coupled system of the type shown in FIG. 3, as the rotor is displaced from the stator, the existing rotating magnetic fields (motoring and integrated magnetic bearings) can be strengthened to produce an enhanced axial restoring force among all participating axial segments, as well as maintaining the normal electromechanical work produced by these magnetic fields. Up to the saturation limit of the magnetic flux-carrying material, the rotating air gap magnetic fields (both normal machine action and integrated magnetic bearings action) can be increased to produce a strengthened axial shear force between the rotor and stator of individual machine segments.

Therefore, the axial force equation is simply equal to the number of participating rotor/stator segments. For equally sized or powered segments the axial force equation for the system becomes

$$\begin{matrix}{F}_{axial} = [ \frac{π {μ}_{0} D}{4 g} ( {F}_{s}^{2} + {F}_{r}^{2} + 2 {F}_{s} {F}_{r} cos δ ) sin θ ] \times \\ number \cdot of \cdot segments\end{matrix} \qquad ( 16 )$$

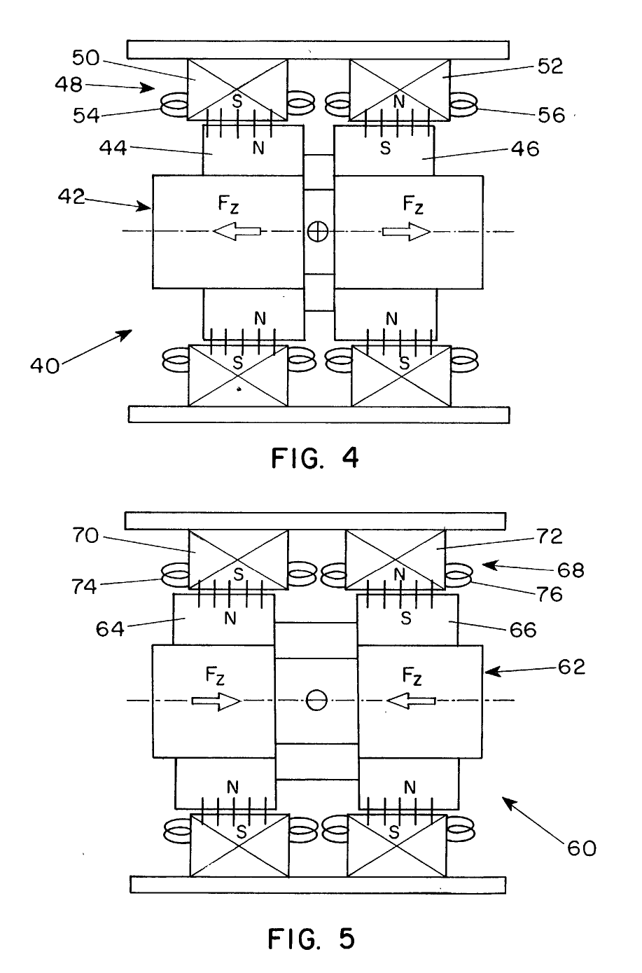

FIGS. 4 and 5 illustrate cases in which non-zero initial angle of displacement is produced by offsetting rotor segments axially with respect to the correspondingly stator segments. In FIG. 4 a machine 40 has a rotor 42 with rotor segments 44 and 46 which are displaced inwardly with respect to corresponding stator segments 50 and 52 of a stator 48, providing initial outwardly directed axial forces F_{z} on the rotor, and in FIG. 5 a machine 60 has a rotor 62 with rotor segments 64 and 66 which are displaced inwardly with respect to corresponding segments 70 and 72 of a stator 68, producing initial inwardly directed axial forces F_{z} on the rotor.

These embodiments are similar to the symmetrically aligned and coupled, zero initial angle of displacement embodiment of FIG. 1 except that the offset rotor-stator segment pairs are coupled to provide segments with non-zero initial angles of displacement. Thus each rotor segment becomes asymmetrically aligned with its stator segment due to the competing axial forces developed by adjacent rotor-stator segments. Working together, rotor-stator segments that are individually asymmetric with their corresponding stators will generate a system symmetry, and a natural system centering force will develop. By utilizing the competitive axial force nature of the individual rotor-stator segments that will be present at all times, controlled axial forces can be generated even when there has been no force-induced disturbance from the natural center position of the system.

With the rotor segments offset inwardly with respect to the stator segments in a multiple rotor-stator segment system, the system non-zero initial angle of displacement centering force is the result of competing axial tension forces. Each rotor segment is attempting to center itself with its corresponding stator segment and find the lowest possible energy state for that machine segment. The result is that the system establishes a new equilibrium point where the competing axial forces are balanced and the system has found its lowest possible energy state. Likewise, with the rotors offset outwardly in a multiple rotor-stator segment system, the system non-zero initial angle of displacement centering force is the result of competing axial compressive forces. Either arrangement allows for the injection of a control current and axial force production whether there has been an initial axial force disturbance or the system is initially undisturbed.

Similar to the zero initial angle of axial displacement method described above with respect to FIG. 1, the AC motoring/generating currents and the integrated magnetic bearings currents can be manipulated to alter the relative strengths of the air gap flux levels in adjacent offset rotor-stator segments and hence alter the relative attractive axial shear forces in adjacent axial segments. Upon any small axial disturbances in a competing pair of non-zero initial angles of displacement rotor-stator segments, the angle of displacement of one segment will grow while the displacement angle of the other segment decreases. Strengthening the AC current signal and hence the magnetic field produced by the larger angle of displacement segment, relative to the magnetic field produced by the smaller angle of displacement segment, will provide a significant axial restoring force.

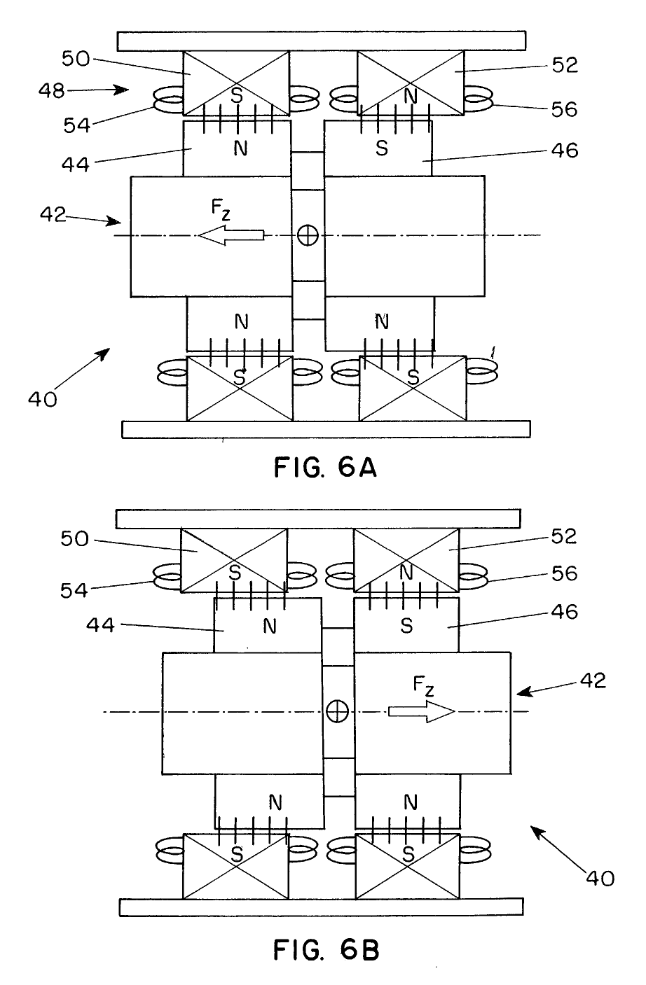

Enhancing the current signals fed to one side of the stator while maintaining or weakening the current signals of the-other side of the stator of an inwardly biased rotor-stator paired segment system will produce a net axial force in the direction of the strengthened-field segment. This is illustrated in FIGS. 6A and 6B. In FIG. 6A a stronger current signal has been applied to the winding 54 than to the winding 56, causing the axial force F_{z} applied to the rotor segment 44 to increase, moving that segment to a centered position with respect to the corresponding stator segment 50, while in FIG. B a stronger current is applied to the winding 56 than the current applied to the winding 54, causing the axial force F_{z} applied to the rotor segment 46 to increase, moving that segment to a centered position with respect to the corresponding stator segment 52.

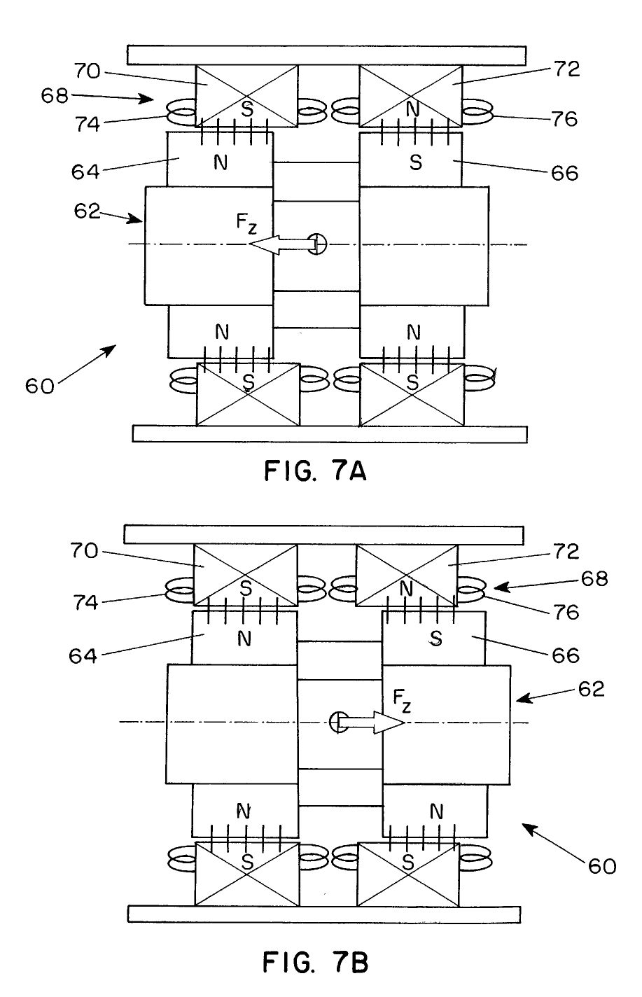

Likewise, enhancing the current signals fed to one side of the stator while maintaining or weakening the current signals of the other side of the stator of an outwardly biased rotor-stator segment paired system will produce a net axial force in the direction of the weakened segment. This is shown in FIG. 7A, in which a stronger current is applied to the winding 76 than to the winding 74, and in FIG. 7B, in which a stronger current is applied to the winding 74 than to the winding 76.

Thus, by enhancing the AC fields in one rotor-stator segment relative to the other rotor-stator segment in a paired system, controlled and directed axial forces can be produced and transmitted throughout the axially segmented permanent magnet synchronous machine with integrated magnetic bearings.

The individual rotor-stator segments participating in the embodiments of FIGS. 4 and 5 are asymmetrically aligned or axially biased with respect to their natural centered positions and hence, each segment starts with non-zero, small angles of axial displacement. Depending on system design the initial angles of displacement of all participating axial segments may or may not be equal to each other.

Because both segments, whether in a inward or outward biased system, start with competing initial axial displacements as the naturally centered position of the axially segmented system, axial force production, from strengthening the field on one segment while maintaining or weakening it on the other, can take place whether or not the system has experienced an axially applied force and/or displacement.

Fₐₓᵢₐₗ=F_{axial·Left}−F_{axial Right} (17)

From the same parameter definitions set forth earlier and with subscript designations of “L” for the “left” segment(s) and “R” for the “right” segment(s), the two segment axial force production equation becomes:

$$\begin{matrix}{F}_{axial} = \frac{π {μ}_{0} D}{4 g} [ ( {F}_{sL}^{2} + {F}_{rL}^{2} + 2 {F}_{sL} {F}_{rL} cos {δ}_{L} ) sin {θ}_{L} - \\ ( {F}_{sR}^{2} + {F}_{rR}^{2} + 2 {F}_{sR} {F}_{rR} cos {δ}_{R} ) sin {θ}_{R} ]\end{matrix} \qquad ( 18 )$$

It must be noted that this concept can readily be utilized for any number of force-matched “left” and “right” segments. Also, the “left” and “right” segments do not have to be of equal number nor do they have to be near each other or grouped in any particular way. Thus, there is much design flexibility in the implementation of this concept.

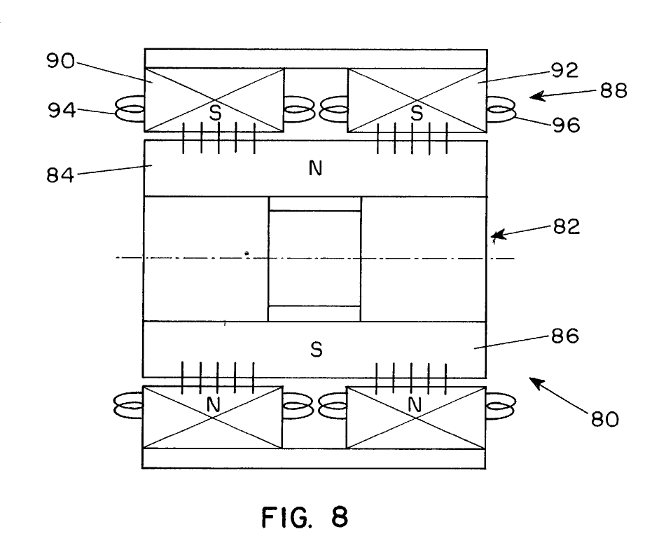

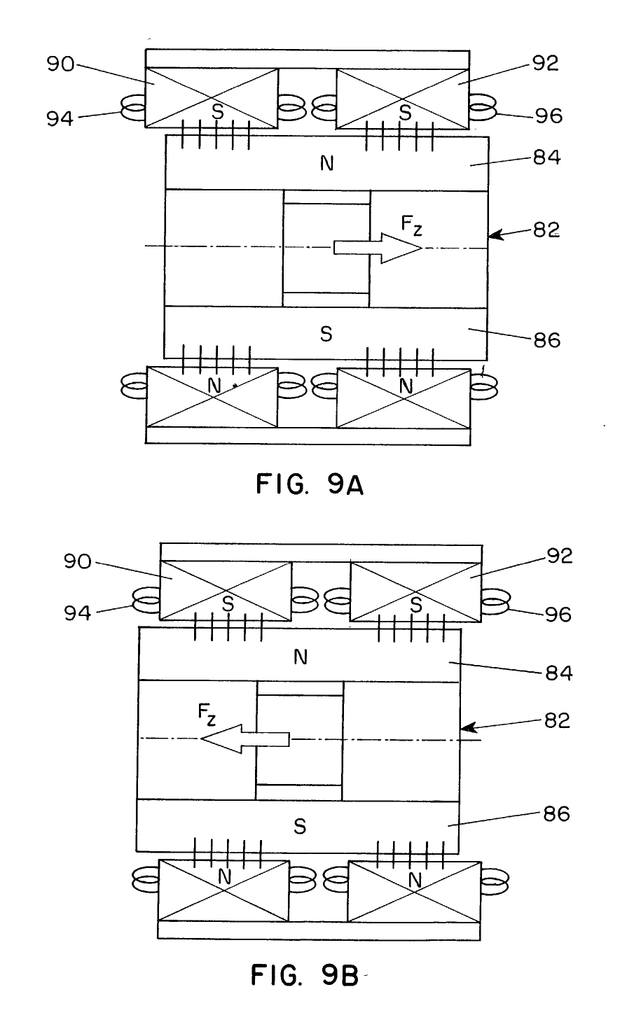

The non-zero initial angle of displacement method can also be utilized effectively with a segmented stator paired with an unsegmented rotor to generate active six-degrees of freedom stabilization and control. This is illustrated in the embodiment of FIG. 8 in which a machine 80 has a single segment rotor 82 with magnets 84 and 86 and a stator 88 with two segments 90 and 92 having corresponding windings 94 and 96. Like the segmented stator—segmented rotor non-zero initial angle of axial displacement embodiments of FIGS. 4 and 5, strengthening of the magnetic fields in one stator segment while maintaining or weakening the field in the adjacent stator segment will cause a directed and controllable axial force in the segmented stator—unsegmented rotor system as shown in FIG. 9A in which a stronger current is applied to the winding 96 of the stator segment 92 and in FIG. 9B in which a stronger current is applied to the winding 94 in the stator segment 90.

Similar to the segmented stator—segmented rotor system, the segmented stator—unsegmented rotor system can also produce a directed and controlled axial force whether the system has been initially axially disturbed or if the system is undisturbed in its natural centered position. Additionally, the range of motion and hence the axial force generated in the segmented stator—unsegmented rotor system may be greater than in the segmented stator—segmented rotor non-zero initial angle of axial displacement. Because there is a common unsegmented rotor shared by more than one stator segment, greater care may be required in operating a system of this type when compared to the previously discussed segmented stator—segmented rotor system. Due to the magnetic isolation between the rotor-stator segments in the segmented stator—segmented rotor system, the number of magnetic poles and their alignment in one segment with respect to its paired rotor—stator segment is not an issue. With a segmented stator—unsegmented rotor system, the inherent magnetic coupling present requires both stator fields to be in synchronism with each other while operating on the common rotor.

If desired, an axially segmented permanent magnet synchronous machine with integrated magnetic bearings in accordance with the invention may contain rotor/stator sections axially offsetting some or all of the rotor/stator integrated magnetic bearings sections for the purpose of active axial position control and stabilization or sections that are of unequal axial length and/or radius and/or different magnetic pole number and/or power level relative to other stator/rotor sections.

Also, axially segmented permanent magnet synchronous machines with integrated magnetic bearing rotor/stator segments in accordance with the invention may be designed, built, or operated for motoring/generating functions exclusively or periodically or for magnetic bearing action exclusively or periodically within a greater set of axially segmented permanent magnet synchronous machine with integrated magnetic bearings.

Moreover, such axially segmented permanent magnet synchronous machines with integrated magnetic bearings may have more than two rotor/stator segments for enhanced system dynamic stiffness, application flexibility, and performance optimization as well as the ability to provide six-degrees of freedom control of the complete machine system and six-degrees of freedom control and stabilization on localized areas of the working shaft and/or any attached subsystems or components.

An axially segmented permanent magnet synchronous machine with integrated magnetic bearings in accordance with the invention may have axial rotor/stator segments that are either adjacent or separated by significant distances and may include working machinery, power transfer components, and work producing elements between axial segments or as part of the rotor/stator segments. Likewise, such an axially segmented permanent magnet synchronous machine with integrated magnetic bearings may be constructed with conventional motoring/generating stator windings and magnetic bearing windings as a single set of multi-pole, multi-phase windings on a common stator or with separate and unique machine and magnetic bearing windings but magnetically integrated on a common stator.

By utilizing the existing stator windings of an axially segmented permanent magnet synchronous machine with integrated magnetic bearings, the development of complete six-degrees of freedom stabilization and control of an axial machine system is possible. Even severe axial loading may be stabilized and controlled with the application of the active axial stator control as discussed above. Further, six-degrees of freedom stabilization and control is accomplished in accordance with the invention without the use of any mechanical bearings and/or any separately mounted magnetic bearings in the machine system. Thus, the inefficiency, reliability/maintainability, noise, and cost concerns of mechanical bearings and the volume, cost, and complexity concerns of separately mounted magnetic bearings are avoided. In addition to active stabilization and control of the forces and moments for the complete machine system, the invention also provides active vibration and noise cancellation in six-degrees of freedom for the complete system as well as offering the ability to stabilize and control the localized degrees of freedoms of any local areas of interest and/or subsystems attached to the master system.

Although the invention has been described herein with reference to specific embodiments, many modifications and variations therein will readily occur to those skilled in the art. Accordingly, all such modifications and variations are included within the scope of the invention.

We claim:

1. A permanent magnet synchronous machine comprising:
a rotor having a plurality of angularly spaced permanent magnets; and
a stator having a plurality of axially spaced segments, each segment including windings for generating magnet field components in response to applied AC signals for interaction with the rotor magnets to apply torque to rotate the rotor within the stator and to support the rotor centrally with the stator, the stator windings also being responsive to applied AC signals to produce an axial restoring force to the rotor in response to axial displacement of the rotor away from a selected axial position within the stator.

2. A permanent magnet synchronous machine system in accordance with claim 1 wherein the rotor has a plurality of axially spaced segments and comprising paired rotor and stator segments in which rotor and stator segments are axially offset from each other.

3. A permanent magnet synchronous machine system in accordance with claim 1 wherein the rotor has a plurality of axially spaced segments and comprising axial rotor and/or stator segments that are of different axial or radial dimension and/or power level then that of other axial segments.

4. A permanent magnet synchronous machine system in accordance with claim 1 further comprising at least one power transferring device coupled to a shaft supporting rotor segments.

5. A permanent magnet synchronous machine system in accordance with claim 1 including at least one stator segment powered for torque-applying action and at least one stator segment powered for integrated magnetic bearings action.

6. A permanent magnet synchronous machine system in accordance with claim 1 wherein the stator windings can receive signals to effectuate anti-vibration, torsion, and noise control in the six controllable degrees of freedoms.

7. A permanent magnet synchronous machine in accordance with claim 6 wherein flexural shaft modes are attenuated by forces and/or moments produced by the stator windings.

8. A permanent magnet synchronous machine in accordance with claim 1 including a control unit for supplying AC signals to the windings to generate motor torque, produce magnetic bearing forces for the rotor, and control the axial position of the rotor.

9. A permanent magnet synchronous machine in accordance with claim 1 wherein the rotor is an axially integral component.
